(19) United States
(12) Patent Application Publication
(10) Pub. No.: US 2009/0038115 A1
(43) Pub. Date: Feb. 12, 2009

(54) Hinge

(75) Inventor: Kuo-Nan Wu, Shulin City (TW)

Correspondence Address: APEX JURIS, PLLC, 12360 LAKE CITY WAY NORTHEAST, SUITE 410, SEATTLE, WA, 98125, US

(73) Assignee: SHIN ZU SHING CO., LTD., Shulin City (TW)

(21) Appl. No.: 11/836,513

(22) Filed: Aug. 9, 2007

(51) Int. Cl. E05D 7/00

(52) U.S. Cl. 16/221

(57) ABSTRACT

A hinge is mounted between a cover and a base of an electronic device and has a pivoting bracket, a rotating bracket and a collar assembly. The pivoting bracket is mounted on the stationary leaf and has a tube protrudes transversely on an outside wall of the pivoting bracket. The rotating bracket is mounted around the tube and has at least one detent formed in a top surface of the rotating bracket. The collar assembly is mounted around the tube and has a positioning collar. The positioning collar has at least one protrusion selectively engaging the at least one detent. Even though the engaging surface between the at least one detent and the at least one protrusion is worn away, the interface between the brackets stays flat and the cover of the electronic device remains mounted stably on the base.

### BACKGROUND OF THE INVENTION

1. Field of the Invention

The present invention relates to a hinge, especially to a hinge that pivotally connects a cover to a base of an electronic device to allow the cover to pivot and rotate relative to the base.

2. Description of the Prior Arts

Electronic devices such as: laptops, mobile phones, digital cameras, and the like have a base, a cover and a hinge. The hinge pivotally connects the cover to the base.

A conventional hinge that allows the cover to pivot relative to the base and rotate comprises a pivoting bracket, a stationary tube, a rotating bracket, rotating tube, a stationary leaf and a rotating assembly.

The pivoting bracket is mounted in the base. The stationary tube protrudes transversely from the pivoting bracket and has an annular edge and multiple teeth. The teeth are formed on the annular edge. The rotating bracket is mounted in the cover. The rotating tube protrudes transversely from the rotating bracket and has an annular edge and multiple teeth. The teeth are formed on the annular edge of the rotating tube and engage the teeth of the stationary tube to hold the rotating bracket in a specific position relative to the pivoting bracket.

The stationary leaf is mounted securely in the pivoting bracket to allow the brackets to pivot relative to the base. The rotating assembly is mounted around the brackets to allow the rotating bracket to rotate.

However, over time and extended use, the interfaces of the teeth of the rotating tube or stationary tube can become worn so the rotating bracket cannot be positioned precisely in the pivoting bracket and the cover may sway relative to the base.

To overcome the shortcomings, the present invention provides a hinge to mitigate or obviate the aforementioned problems.

### SUMMARY OF THE INVENTION

The main objective of the present invention is to provide a hinge that remains stable after prolonged use. The hinge is mounted between a cover and a base of an electronic device and has a pivoting bracket, a rotating bracket and a collar assembly. The pivoting bracket has a tube protrudes transversely on an outside wall of the pivoting bracket. The rotating bracket is mounted around the tube and has at least one detent formed in a top surface of the rotating bracket. The collar assembly is mounted around the tube and has a positioning collar. The positioning collar has at least one protrusion selectively engaging the at least one detent. Even though the engaging surface between the at least one detent and the at least one protrusion is worn away, the interface of the brackets stays flat and the cover of the electronic device remains mounted stably on the base.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a hinge in accordance with the present invention;

FIG. 2 is a partially exploded view of the hinge in FIG. 1;

FIG. 3 is a front view in partial section of the hinge in FIG. 1;

FIG. 4 is a top view in partial section of the hinge along line 4-4 in FIG. 3;

FIG. 5 is an operational top view of the hinge in FIG. 1, with the protrusions of the inner positioning collar engaging the detents of the rotating bracket;

FIG. 6 is an operational top view of the hinge in FIG. 1, with the protrusions of the inner positioning collar disengaged from the detents of the rotating bracket; and

FIG. 7 is an operational perspective view of the hinge in FIG. 1, shown mounted in an electronic device.

### DETAILED DESCRIPTION OF THE PREFERRED EMBODIMENTS

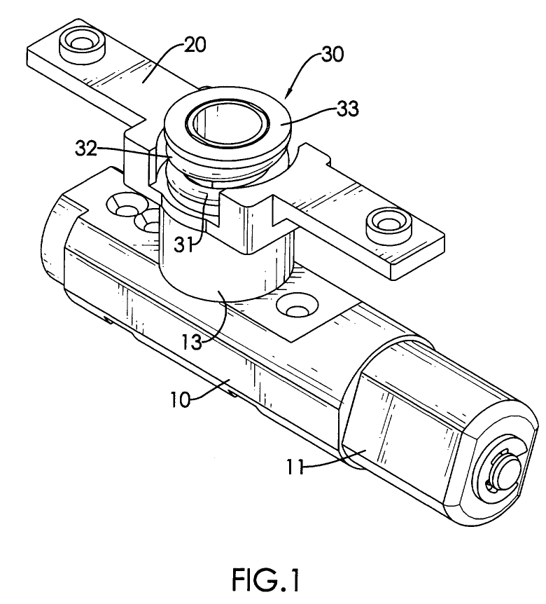

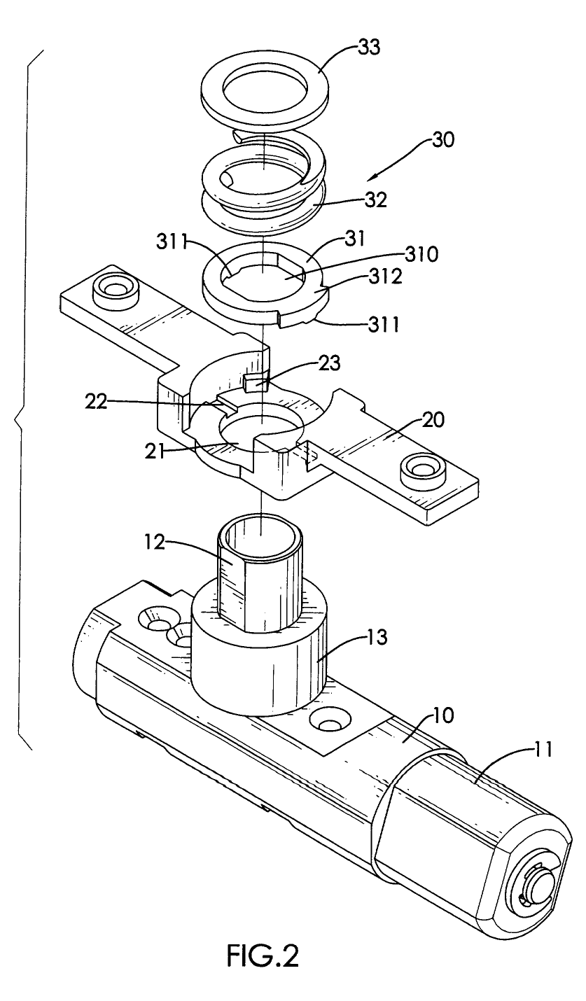

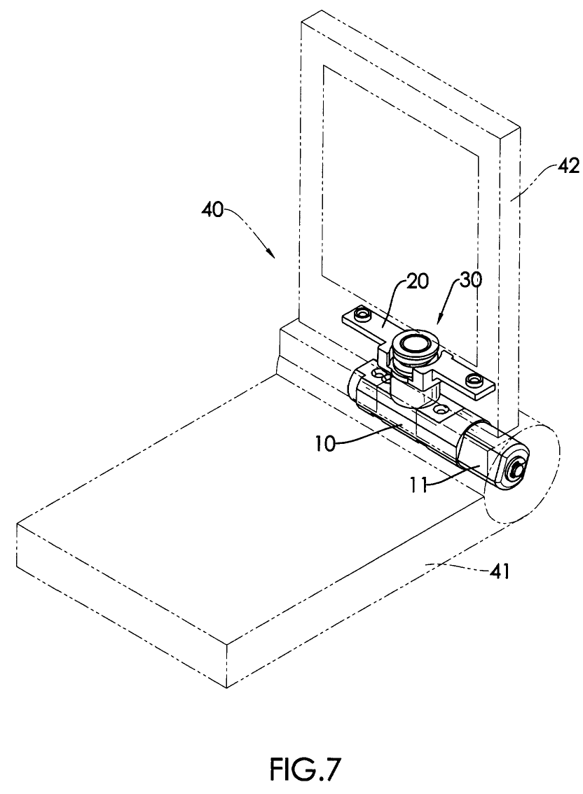

With reference to FIGS. 1, 2 and 7, a hinge is used in conjunction with an electronic device (40) having a cover (42) and a base (41) and comprises a stationary leaf (11), a pivoting bracket (10), a rotating bracket (20) and a collar assembly (30).

The stationary leaf (11) is pivotally mounted in the base (41) of the electronic device (40).

The pivoting bracket (10) is mounted on the stationary leaf (11) and in the base (41) of the electronic device (40), is tubular and has an outside wall, a tube (12) and a sleeve (13). The tube (12) protrudes transversely from the outside wall of the pivoting bracket (10), and has an outside wall and an end. The outside wall of the tube (12) is non-circular in cross-section. The sleeve (13) extends from the outside wall of the pivoting bracket (10) and is formed around the outside wall of the tube (12).

The rotating bracket (20) is mounted in the cover (42) of the electronic device (40), is mounted around the tube (12), has a bottom surface, a top surface, a through hole (21) at least one detent (22) and may have a positive stop (23). The bottom surface of the rotating bracket (20) abuts the sleeve (13). The through hole (21) is formed through the rotating bracket (20) and is mounted rotatably around the tube (12). The at least one detent (22) is formed in the top surface of the rotating bracket (20) near the through hole (21). The positive stop (23) is formed on the top surface of the rotating bracket (20).

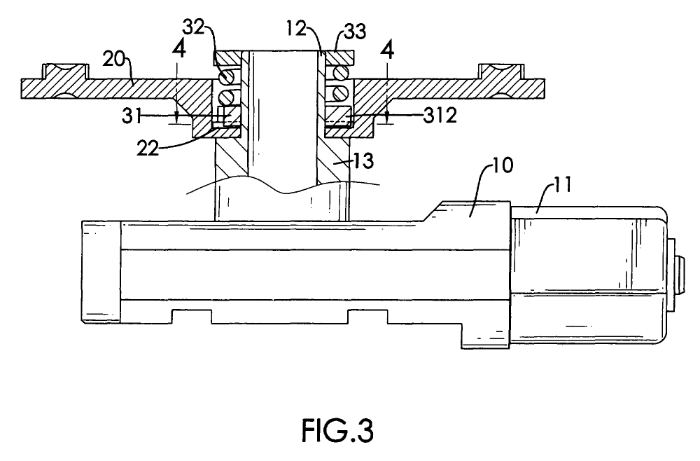

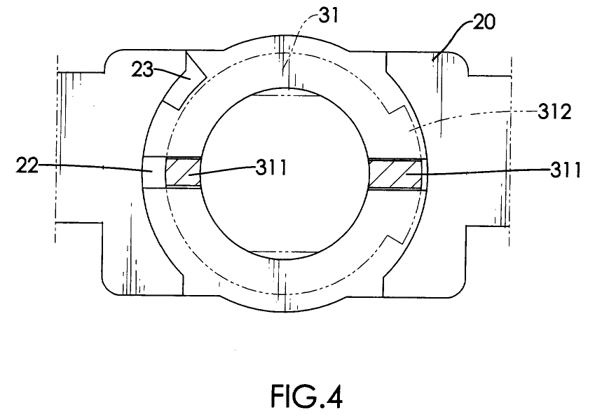

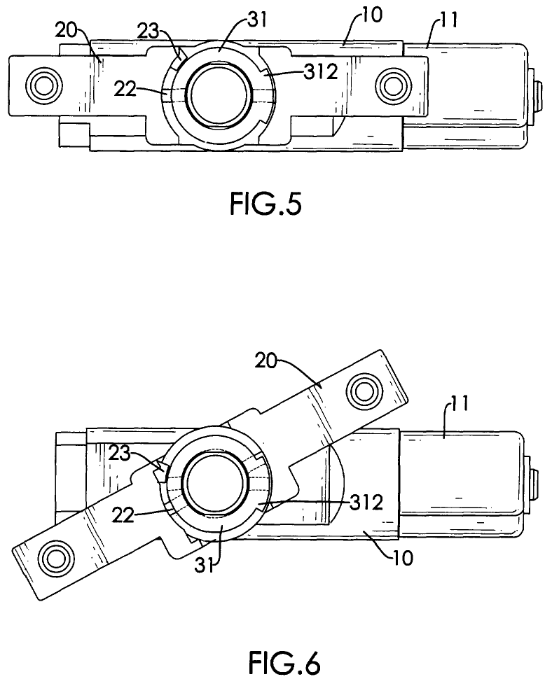

With further reference to FIGS. 3 to 6, the collar assembly (30) is mounted around the tube (12) and has a positioning collar (31), a resilient component (32) and a fastening collar (33).

The positioning collar (31) is mounted securely around the outside wall of the tube (12), has a bottom surface, a top surface, an annular edge, a central hole (310) and at least one protrusion (311) and may have a protruding stop (312). The central hole (310) is non-circular in cross-section, corresponds to the outside wall of the tube (12) and engages the outside wall of the tube (12). The at least one protrusion (311) is formed radially on the bottom surface of the positioning collar (31) and corresponds to and selectively engages the at least one detent (22) of the rotating bracket (20) to hold the rotating bracket (20) in specific positions relative to the pivoting bracket (10). The protruding stop (312) is formed around the annular edge of the positioning collar (31) and has two ends. The ends selectively abut the positive stop (23) to stop rotation of the rotating bracket (20).

The resilient component (32) is mounted around the tube (12), abuts the top surface of the inner positioning collar (31) and may be a spring, multiple elastic washers or the like.

The fastening collar (33) is mounted securely around the end of the tube (12) and abuts the resilient component (32) to hold the rotating bracket (20), the positioning collar (31) and the resilient component (32) tightly between the sleeve (13) and the fastening collar (33).

The hinge as described has the following advantages. The rotating bracket (20) is held in specific positions relative to the pivoting bracket (10) by the at least one detent (22) of the rotating bracket (20) engaging the at least one protrusion (311) of the inner positioning collar (31). The interfaces between the brackets (10, 20) are flat. Thus, even though the engaging surface between the at least one detent (22) and the at least one protrusion (311) is worn away, the interface between the brackets (10, 20) stays flat and the cover (42) of the electronic device (40) remains mounted stably on the base (41). Furthermore, the positive stop (23) of the rotating bracket (20) selectively abutting the protruding stop (312) of the inner positioning collar (31) limits the rotating angle of the cover (42).

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A hinge comprising
a stationary leaf;
a pivoting bracket being mounted pivotally on the stationary leaf, being tubular and having
an outside wall;
a tube protruding transversely from the outside wall of the pivoting bracket and having
an outside wall being non-circular in cross-section; and
an end; and
a sleeve extending from the outside wall of the pivoting bracket and being formed around the outside wall of the tube;
a rotating bracket mounted around the tube and having
a bottom surface abutting the sleeve;
a top surface;
a through hole being formed through the rotating bracket and being mounted rotatably around the tube; and
at least one detent being formed in the top surface of the rotating bracket near the through hole; and
a collar assembly mounted around the tube and having
a positioning collar being mounted securely around the outside wall of the tube and having
a bottom surface;
a top surface;
an annular edge;
a central hole being non-circular in cross-section, corresponding to the outside wall of the tube and engaging the outside wall of the tube; and
at least one protrusion being formed radially on the bottom surface of the positioning collar and corresponding to and selectively engaging the at least one detent of the rotating bracket;
a resilient component being mounted around the tube and abutting the top surface of the positioning collar; and
a fastening collar being mounted securely around the end of the tube and abutting the resilient component.

2. The hinge as claimed in claim 1, wherein
the rotating bracket further has a positive stop being formed on the top surface of the rotating bracket; and
the positioning collar further has a protruding stop being formed around the annular edge of the positioning collar and having two ends selectively abutting the positive stop.

3. The hinge as claimed in claim 1, wherein the resilient component is a spring.

4. The hinge as claimed in claim 2, wherein the resilient component is a spring.
